(19) United States
(12) Patent Application Publication
(10) Pub. No.: US 2014/0089384 A1
(43) Pub. Date: Mar. 27, 2014

(54) SERVER RESOURCE SELECTION ON A NETWORK FOR A MOBILE CLIENT

(71) Applicant: INTERNATIONAL BUSINESS MACHINES CORPORTION, Armonk, NY (US)

(72) Inventors: Angel L. Diaz, Carmel, NY (US); David L. Kaminsky, Chapel Hill, NC (US); Todd M. Moore, Georgetown, TX (US)

(73) Assignee: International Business Machines Corporation, Armonk, NY (US)

(21) Appl. No.: 13/628,974

(22) Filed: Sep. 27, 2012

(51) Int. Cl. G06F 15/16

(52) U.S. Cl. 709/203

(57) ABSTRACT

A method, system, and computer-readable storage media for providing requested resources to a mobile client. In one embodiment, a method includes acquiring information about a request for network resources for a session by a mobile client. The method may include predicting an itinerary of the mobile client for the session and also predicting a connection speed of the mobile client using the predicted itinerary. The predicted connection speed of the mobile client may be used to identify network resources for the session.

### TECHNICAL FIELD

Embodiments described herein generally relate to identifying network resources for a client of a network, and more specifically to identifying network resources for a mobile client changing service areas.

### BACKGROUND

A network is a collection of computers and other hardware components interconnected by communication channels that allow sharing of network resources and information. Where at least one process in one device is able to send/receive data to/from at least one process residing in a remote device, then the two devices are said to be in a network. Generally, more than one computer interconnected through a communication medium for information interchange is called a computer network. Modern devices often use networks to connect with servers for information and services. The need for mobile devices to connect to, and interact with, a network is now common.

### SUMMARY

In one embodiment, a method is provided for identifying resources for a requesting mobile client. A method includes acquiring information about a request for network resources for a session by a mobile client. The method includes predicting an itinerary of the mobile client for the session and also predicting a connection speed of the mobile client using the predicted itinerary. The predicted connection speed of the mobile client may be used to identify network resources for the session.

In another embodiment, a system is provided for identifying resources for a mobile client. The system includes a server that may receive a request for network resources from the mobile client. The server may operate to predict an itinerary for the mobile client for a session and to predict a connection speed for the mobile client using the predicted itinerary for the session. The server may also operate to identify a network resource for the mobile client using the predicted connection speed of the mobile client.

### BRIEF DESCRIPTION OF THE DRAWINGS

FIG. 1 depicts a high-level block diagram of an exemplary system, according to an embodiment of the invention.

FIG. 2A is a functional overview diagram of an embodiment of the invention.

FIG. 2B is a functional overview diagram of an embodiment of the invention.

FIG. 3 is a flowchart of a method for identifying network resources for a mobile client, in accordance with an embodiment of the invention.

In the Figures and the Detailed Description, like numbers refer to like elements.

### DETAILED DESCRIPTION

Modern electronic systems, such as computers, cell phones, and tablets often connect to networks or servers so that they may access network resources controlled or available to those entities. An example of this may be clients accessing game services available through specific servers. The client may request access to a game, available through the server, which involves interacting with other clients. The server may have a variety of network resources available to assign to the client. An example of this may be known as a game room, which is a specific network, server, application, or sublevel of an application that may house several clients so that they may interact with each other while using the network resource.

The connection speed of a specific client to the server may affect the experience of the various clients using the same network resource. This may make it preferable to match clients with similar connection speeds under certain circumstances. The connection speed of a client may vary while using the network resource, thus affecting the client's experience with the network resource. This may result in a need to be able to predict the client's connection speed for the duration of their experience with the network resource, or a session, and identify network resources based upon this prediction. For example, when the client is a non-mobile device, such as a home PC, estimates and assumptions about connection speed based may be considered reliable. Factors such as geographic location and service provider capabilities are constants and may make identifying resources for a client an easy task. A client to a server game, such as an MMO, may be assigned to the server physically closest to the client's physical location as factors that affect connection speed such as routing of communication between client and server may be constant and unchanging. When the client is mobile such assumption start to become less valid. For mobile clients the connection speeds may vary to a greater extent than non-mobile clients. Many factors may contribute to the varied connection speed a mobile client may experience, including but not limited to: distance from wireless connection providers, weather, geography, differences with a provider's infrastructure, changes in connection providers during travel, and interference from other electronic devices.

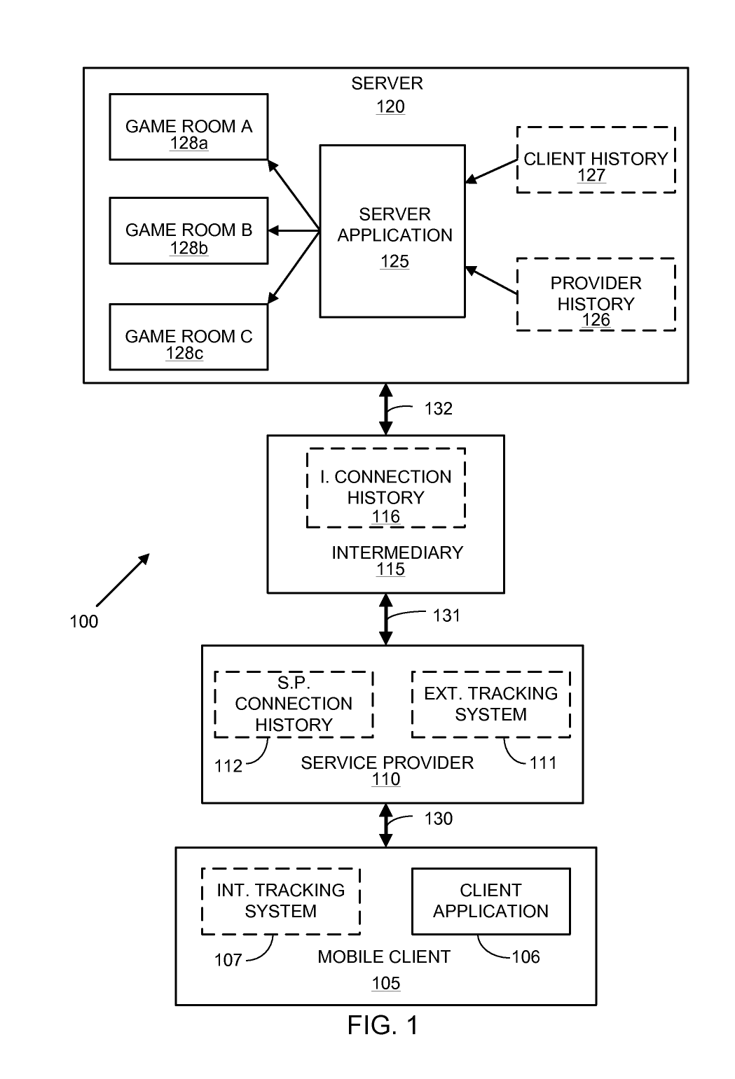

FIG. 1 depicts a high-level block diagram representation of an apparatus 100 including mobile client 105 accessing a server application 125 and the identification and assignment of a network resource, a game room 128, according to an embodiment. A client application 106 may be computer software on the client 105 that may be designed to help the user perform specific tasks using network resources available to the server 120 and server application 125. In one embodiment, the mobile client 105 may host the server application 125, such as for example, in a peer-to-peer system. Examples of client application 106 may include games, enterprise software, graphic software, interactive software, and media players. Typically these client applications 106 may identify and select a network resource from a server 120 or server application 125 by either the mobile client 105 or the server application 125 using current geographic location or current connection speed of the client 105. Identifying and selecting a network resource may affect the network system efficiency, user experience of the mobile client 105, and the experience of other users and clients assigned to the same network resource. These factors may make properly identifying and selecting network resources for a client a valuable task. The identification of such resources for mobile clients may be more complex and more valuable due to their mobility.

The server 105 may be a computer system. The server 105 may include one or more processors, one or more memories, and a network interface for communicating with clients.

In the example embodiment, the network resources available to assign to the client application 106 are game rooms A 128a, B 128b, and C 128c (collectively referred to as 128). In other embodiments, the network resources may vary in number from the three shown in the example. In other embodiments, the network resources may be applications and programs accessible to the server, connected servers, or other mobile clients. The network resources may take any form in which connecting users, or clients, have a selection from which they may be arranged and assigned to use, for example “game rooms” used by many online games services. Identifying the best resources of those available to assign a client to may greatly improve the system efficiency of the network and user experience for the clients.

The mobile client 105 may be, for example, a mobile device such as a mobile phone, mobile computer or laptop computer, or mobile tablet. The mobile client may also be a traditionally non-mobile type of computer or electronic device that is connected or housed in such a way that it may be mobile, for example a desktop computer operated inside bus, van, train, or plane that is provided a mobile connection. The server application 125 may have a capability to predict an itinerary for the mobile client 105 for a predicted duration of a session. The predicted itinerary may include a path of travel or route, timetable for the travel, list of waypoints, expected rate of travel speeds, or any other information relevant the travels of the client 105. A predicted itinerary may allow the server application 125 to identify network resources that match the needs of a mobile client and server for the duration of a session. The predicted itinerary may allow the server application 125 to predict changes in connection speed, such as latency and bandwidth, that may affect the experience of the user. For example, a network resource may be a game room and the user may be playing a multi-player game on a mobile client, such as a mobile phone, while traveling on the predicted itinerary. A user may have a satisfactory experience if he or she experiences latency and bandwidth similar to that experienced by other players of the same game. On the other hand, a user's experience may be less than satisfactory if the user experiences greater latency or less bandwidth than other players. The predicted itinerary may allow the server application 125 to match latency and bandwidth for a user with that of other players.

In one embodiment, the session may be the time period that a client application 106 uses a network resource such as a game room 128. In another embodiment, the session may be the entire time that a client application is in contact with a server application 106, or the session may be the time that a mobile client 105 uses a network resource before being assigned another network resource. For example, for a game application, the session may be the entire time that the mobile client is logged into the server 120 regardless of which game room 128 they are assigned, or the session may include only a single round of play in an assigned game room 128 with a new session beginning with the next game room 128 assignment. The server application 125 may use a predicted duration of time for a session when predicting the itinerary of and identifying network resources for a mobile client 105 to be assigned. For instance, the server 120 may use information such as average session times for all mobile clients, rules for session times, or the optional mobile client history 127 to assist in predicting the duration of time for a session. In various embodiments, any information or source of information available may be used for predicting the duration of time for the session. The estimation of the predicted duration of time for the session may be done outside of the server application 125 or the server 120 itself, for example, in a secondary program accessible to the server application 125. The server application 125 may use the predicted duration of time for a session to predict the itinerary of a mobile client 105 for the session. In one embodiment, some or all of the operations the server 120 performs may be performed in the intermediaries 115, service provider 110, or client 105.

The mobile client 105 may be connected with the server 120 and server application 125 as shown. The mobile client 105 is connected with a service provider 110 using connection 130. The service provider 110 may be connected with an intermediary 115 using connection 131, and the intermediary may be connected with the server 120 using connection 132. An intermediary may be any provider of channels of communication between the service provider 110 and the server 120, one example of which may be an Internet exchange point (IXP) which is a physical infrastructure through which Internet service providers (ISPs) exchange Internet traffic between their networks. Connections 130, 131, and 132 may be may be direct connections, network connections, or wireless connections. Network connections may be public or private networks and may be made of a single network or a system of interconnected networks. The networks may link the server 120, intermediary 115, service provider 110, and mobile client 105 by wire, wirelessly, via optical fiber, or by any suitable physical transmission media. As one example, the network between two elements may be the Internet. As another example, the network may be a private Ethernet network. In various embodiments, networks and channels between the client 105 and server 120 may have many variations that are within the scope of invention. The combination and types of these connections may vary as the mobile client 105 moves along the predicted itinerary during a session.

The server application 125 may determine the predicted itinerary by using information about the mobile client's 105 current location, direction of travel, velocity, and recent movement. Information such as location, direction, and velocity may be provided by the optional internal tracking system 107 in the mobile client 105, which may, for example, be an output from a mobile device's global positioning system (GPS). The information may also be provided by an optional external tracking system 111 that is shown as part of the service provider 110. In various embodiments, determining the predicted itinerary may also include using historical data in conjunction with the current location, direction of travel, and velocity to create a predicted path of travel for the client 105. Several optional forms of historical data are shown including: service provider history 112, intermediary connection history 116, provider history 126, and mobile client history 127. Each of these, and other historical data not listed but available to assist in predicting an itinerary for a mobile client, may be used in combination with the current location, direction of travel, and velocity data provided by the GPS and may provide information used in predicting the itinerary, for example the location of common stops and travel routes. For example, the predicted itinerary may be created by factoring in that a specific server application 125 is historically accessed by clients 105 traveling between two specific points on a specific travel path. The prediction of the itinerary of the mobile client 105 may be done outside of the server application 125 or the server 120 itself, for example, in a secondary program accessible to the server application 125.

The server application 125 may predict a connection speed of the mobile client. The predicted connection speed may be useful in providing a satisfactory experience for the user of a mobile client 105. For example, the predicted connection speed may allow the server application 125 to assign a network resource, such as a game server hosting a multi-player game, to the user's mobile client that provides a connection speed that is similar to the connection speeds of other players of the same game The server application 125 may use predicted duration of time for the session in the predicted itinerary of the mobile client 105 to determine the predicted connection speed or possible changes in connection speed during the session. Further, the server application 125 may use a predicted itinerary in its determination of a predicted connection speed. In addition, other factors that may be used in determining the predicted connection speed for the mobile client 105 may include, but are not limited to: changes in connection between mobile client 105 and provider 110, changes to provider 110, changes in intermediary 115, changes in connection between provider 110 and intermediary 115, changes in connection between intermediary 115 and server 120. One skilled in the art will appreciate the variety of factors that can affect connection speed of the mobile client 105 during a session. The predicted connection speed may be determined using connection speed tests with service providers 110 and intermediaries 115 along the predicted itinerary of the mobile client 105. The predicting of connection speed may also use historical data of the service providers 110 and intermediaries 115 along the predicted itinerary. For example, the optional provider history 126, intermediary connection history 116, and service provider connection history 112 may be accessed to acquire historical data for the prediction. The prediction of a connection speed of the mobile client may be done outside of the server application 125 or the server 120 itself, for example, in a secondary program accessible to the server application 125.

The server application 125 may identify network resources for the mobile client 105 to use based on the predicted connection speed of the mobile client 105 to the server 120. The identification of such network resources may be based on connection speeds or predicted connection speeds of other mobile clients assigned to the same network resources. In other embodiments, the identification of such network resources may be based upon rules for minimum, maximum, or a specified range of connection speeds allowed access to various network resources. For example, a mobile client 105 may have a predicted connection speed of 400 ms latency and 1 Mbit/sec throughput. The server application 125 may use this information to identify network resources, game rooms 128, available based upon this prediction. Game room A 128a may have a required minimum predicted speed of 500 ms latency and throughput of 1 Mbit/sec. Game room B 128b may have a required predicted speed range of 300 ms-600 ms latency and throughput of 0.75 Mbit/sec-1.3 Mbit/sec, and game room C 128c may have required minimum predicted speed range of 300 ms latency and throughput of 1.7 Mbit/sec. In this example, since the predicted connection speed of the mobile client 105 is predicted to match the requirements of game room A 128a and game room B 128b the server application 125 may identify them as possible network resources for the mobile client 105. In various embodiments the mobile client history 127 or mobile client preferences may be used in combination with the predicted connection speed to identify network resources for the mobile client 105. In other embodiments, the rules or guidelines for the network resources may change based upon load and demand for various mobile clients 105. One skilled in the art will appreciate the variety of factors that can affect identifying network resources for the mobile client 105 and how network resources may be changed for mobile clients 105.

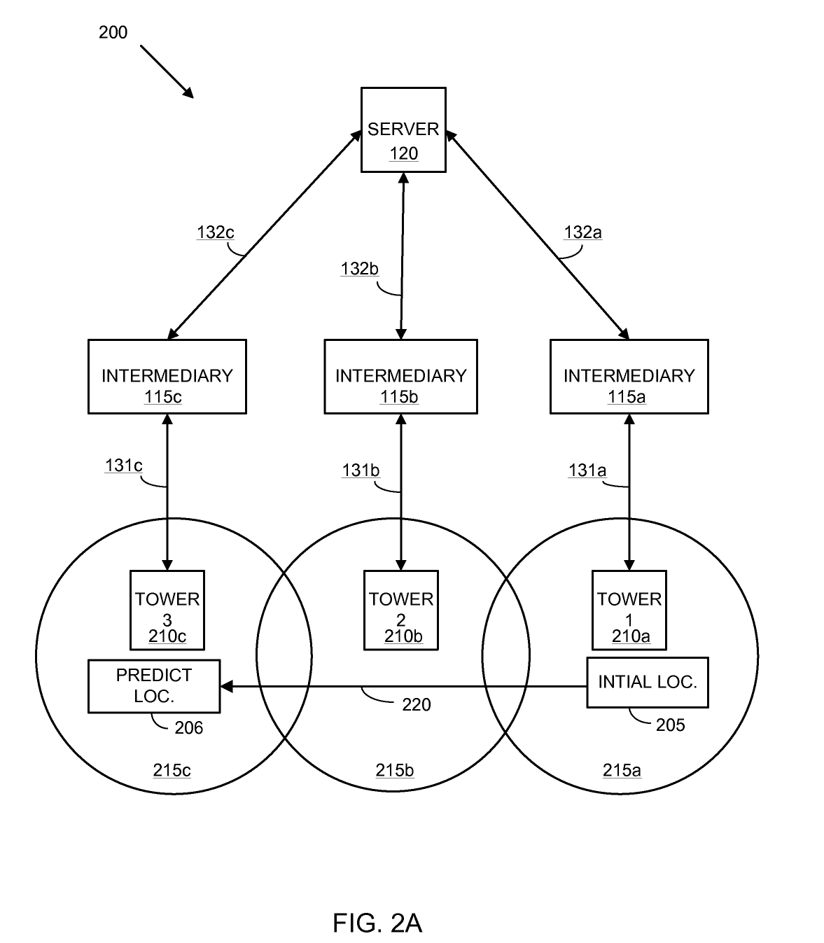

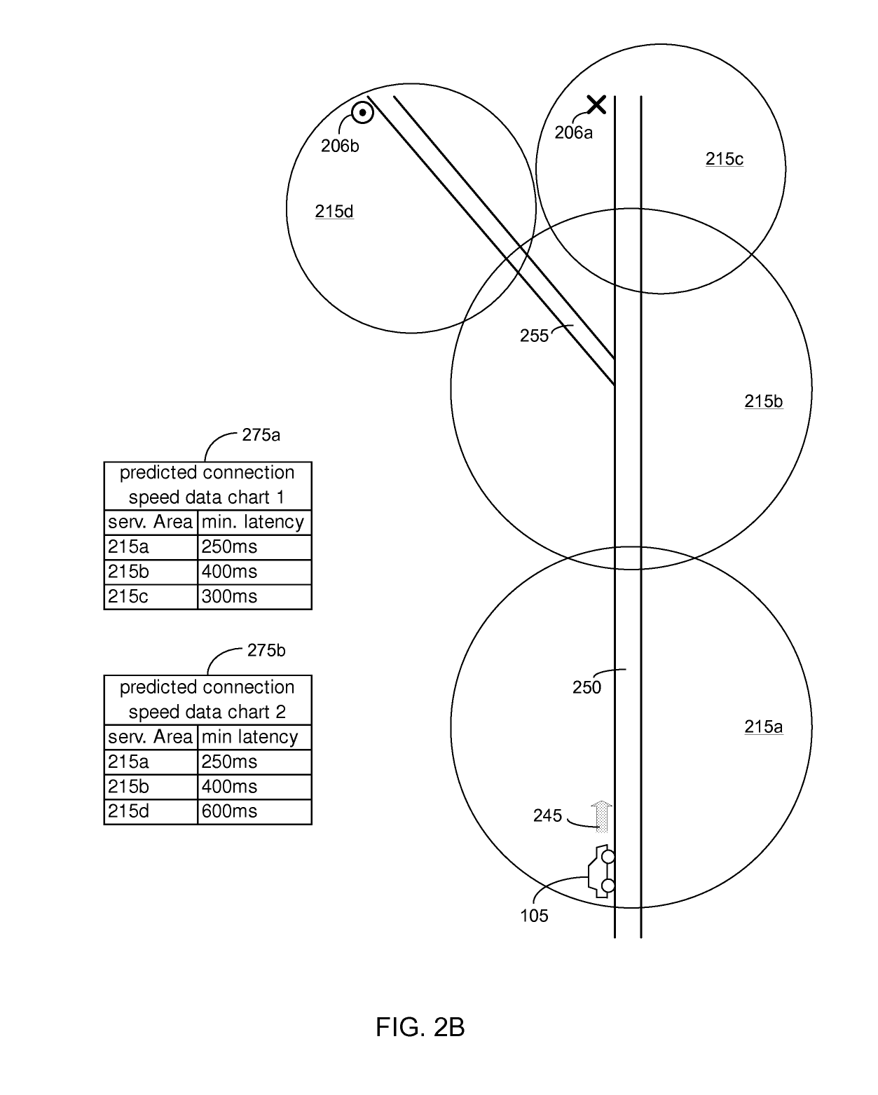

FIGS. 2A and 2B are functional overview diagrams of one embodiment. In one embodiment, service provider 110 uses towers 210a, 210b, and 210c to provide a wireless communication channel to the mobile client 105. Each tower has a service area in which the mobile client 105 may use the tower as a channel, these are, respectively, 215a, 215b, 215c. The service areas of the towers may be various sizes, strengths, speeds, and technologies. The service areas may in various embodiments be operated by different entities, and are considered a service provider because the mobile client may access the server by using a channel that they provide. Towers may refer to cellular towers, and are used only as an exemplary type of equipment used by service providers to enable mobile communication. In other embodiments, various antenna and receiver combinations, satellite technology, or broadcast technology may be used to enable mobile communication with the mobile client within a service area.

In the example embodiment, each individual tower may route the communication from the mobile client 105 to the respective intermediaries 115a, 115b, and 115c using respective connections 131a, 131b, and 131c. The intermediaries 115a, 115b, 115c may route the communication to the server 120 using respective connections 132a, 132b, 132c. As previously described, connections 130, 131, and 132 may be, and irrespective of each other, various types of direct connections, network connections, or wireless connections. In various embodiments, any combination of towers 210, intermediaries 115, and service providers 110 may allow communication between the mobile client 105 and the server 120. One skilled in the art will appreciate the variety of combinations that may be created and used to provide mobile communications to the mobile client 105.

As previously mentioned, a predicted itinerary may allow the server application 125 to identify network resources that match the needs of a mobile client and server for the duration of a session. Matching the needs of the mobile client and server for the duration of a session may allow the user to have a satisfactory experience. In an embodiment, the itinerary of the mobile client 105 may be determined when the mobile client 105 requests network resources at an initial physical location 205. The server application may use the predicted duration of the session along with other information such as location, direction, and velocity to create the predicted itinerary 220 including a predicted final physical location 206 at the end of the session. The predicted itinerary may include a path of travel or route, timetable for the travel, list of waypoints, expected rate of travel speeds, or any other information relevant to predicting the travels of the client 105. Using the predicted itinerary 220 of the mobile client 105, the server application 125 may predict a connection speed of the mobile client 105 for the predicted duration of the session. For example, the mobile client 105 may be predicted to use towers 210a, 210b, and 210c during the session. The server application may use information from or about each of the towers of the service provider 110 and information from or about the respective intermediaries 115a, 115b, and 115c to predict a connection speed of the mobile client 105. For example, the server may “ping”, or test, the connection speed to each tower to create a predicted connection speed of the mobile client 105. Testing connection speed along the itinerary may be used in predicting the connection speed of the mobile client 105 for the session. As previously mentioned, the prediction may also involve the use of historical connection speed data for the prediction. The server application 125 may use this predicted connection speed to identify network resources for the mobile client 105.

FIG. 2B is a functional overview diagram of one embodiment in which mobile client 105 is moving in a direction marked by arrow 245. As mentioned for FIG. 2A, a direction and velocity for the mobile client 105 may be acquired and a predicted itinerary 220 for the predicted session time. In this example, the predicted itinerary 220 during the session ends at either physical location 206a or 206b. Physical location 206a may be determined by using only the velocity and direction of the mobile client 105. For example, the mobile client 105 may be moving at 60 mph (96.6 kmh) in a northern direction and have an estimated session time of 30 minutes. A predicted itinerary 220 in which the mobile client 105 continues along path 250 reaching predicted physical location 206a at the end of the estimated 30 minute session may be determined. Using this predicted itinerary 220, it may be determined that the mobile client may use service areas 215a, 215b, and 215c during the estimated session. Table 275a is an example of a chart that may be created with acquired information about the predicted itinerary 220 of the mobile client 105. Such a table may be created or used by the server application 125, or another program, to determine the predicted connection speed of the mobile client 105 during the session. The example table only shows a minimum latency for each service area. In various embodiments, other data such as throughput, multiple points for each area, effect of distance or range from each tower, differences in various provider's infrastructures, effect of service area overlap, connection speed ranges, connection speed maximums, time of day, and any other data significant to predicting the mobile client's connection speed along a path 250 may be acquired and used for the prediction.

Historical data may be used to determine a predicted itinerary directly or it may used for a predicted path of travel. The predicted path of travel may in turn be used to determine an itinerary. Examples of a predicted path of travel may include, but are not limited to: previously traveled itineraries, known specific travel routes such as flight paths, train routes, and itineraries and traffic conditions designated by other software or applications. In FIG. 2B, a predicted path of travel may be one where the mobile client 105 diverts from path 250 onto path 255. The predicted itinerary may then have the mobile client 105 reaching predicted physical location 206b at the end of the estimated 30 minute session. Using this predicted itinerary 220, it may be determined that the mobile client 105 may use service areas 215a, 215b, and 215d during the estimated session. Table 275b is an example of acquired information about the predicted itinerary 220 of the mobile client 105. Such a table may be created or used by the server application 125, or another program, to determine the predicted connection speed of the mobile client 105 during the session and may include any of the variations mentioned for table 275a. For example, the predicted itinerary may use the fact that a client is traveling along a highway at the same approximate time and speed as is historically done 5 times a week to estimate a predicted session duration of 25 minutes and a predicted travel path taking the client Northeast 15 miles. This may be used for a predicted itinerary, and thus for a predicted connection speed of the mobile client.

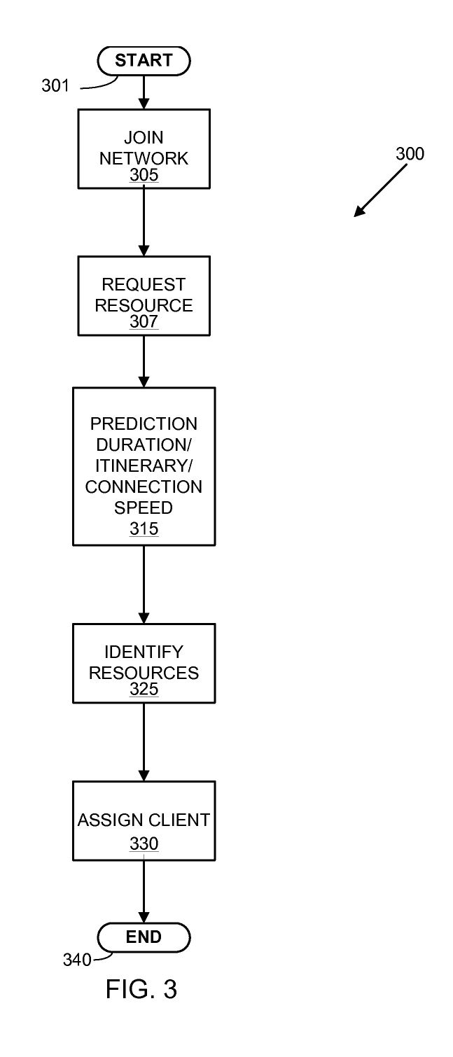

FIG. 3 is a flowchart of a method 300 to assign a mobile client 105 to a network resource by a server application 125. The method starts in block 301 and in block 305 the mobile client 105 may join a network that allows access to the server application 125. In block 307, the mobile client 105 may request to use or be assigned to a network resource available to the server application 125.

Block 310 may involve predicting session duration, itinerary, or connection speed for the mobile client 105. In one embodiment, information acquired such as average session times for the mobile client 105, rules for session times, or the optional mobile client history 127 assist in predicting the duration of time for a session. The prediction of duration may also be accomplished as previously described in regards to FIG. 1 and FIG. 2. In one embodiment, the predicted itinerary 220 may be determined by using information acquired about the mobile client 105, for example: location, direction, velocity, and recent movements. The predicted itinerary 220 may also be determined with information acquired as previously described in regards to FIG. 1 and FIG. 2. For example, the use of a predicted path of travel may be used in predicting the itinerary. In various embodiments, this may include the use of information such as train or plane routes that the client 105 is known to historically take. The predicted connection speed may be made using the predicted itinerary 220 of the mobile client 105 to determine likely changes in service areas 215 and other factors that that may be considered in the prediction as previously mentioned. In various embodiments, the prediction of session duration, itinerary, and connection speed may be done in various orders or in parallel.

In block 325, the server application may identify network resources for the mobile client 105. In various embodiments, the identification of network resources may use the predicted connection speed. For example, network resources may be identified by a minimum predicted connection speed. In other embodiments, resources may be based upon a defined range for the predicted connection speed. The variety of ways such resources may be identified will be appreciated by one skilled in the art. In block 330, the mobile client 105 is assigned a network resource or network resources. As previously mentioned, the final assignment of network resources may factor in more than just the predicted connection speed for example: mobile client history, user preferences, and system workload distribution to name just a few. Individual blocks of the method 300 may be performed by different entities alone or in various combinations. The method 300 then ends in block 340.

Exemplary embodiments have been described in the context of a fully functional system for predicting connection speed 320 for a mobile client 105 and identifying network resources 325 for the mobile client 105 using the predicted connection speed 320. Readers of skill in the art will recognize, however, that embodiments also may include a computer program product disposed upon computer-readable storage medium or media (or machine-readable storage medium or media) for use with any suitable data processing system or storage system. The computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer or storage system having suitable programming means will be capable of executing the steps of a method disclosed herein as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the claims.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be used. The computer readable medium may be a computer-readable signal medium or a computer-readable storage medium. The computer readable signal medium or a computer readable storage medium may be a non-transitory medium in an embodiment. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire, optical fiber cable, RF, etc., or any suitable combination of the foregoing.

Computer program code for carrying out operations for aspects may be written in any combination of one or more programming languages, including an object-oriented programming language such as Java, Smalltalk, C++ or the like and conventional procedural programming languages, such as the C programming language or similar programming languages. The program code may execute entirely on the user's computer, partly on the user's computer, as a stand-alone software package, or on one module or on two or more modules of a storage system. The program code may execute partly on a user's computer or one module and partly on a remote computer or another module, or entirely on the remote computer or server or other module. In the latter scenario, the remote computer other module may be connected to the user's computer through any type of network, including a local area network (LAN) or a wide area network (WAN), or the connection may be made to an external computer (for example, through the Internet using an Internet Service Provider).

Aspects are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function or act specified in the flowchart, or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions or acts specified in the flowchart, or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

The terms “server and “mobile client” are used herein for convenience only, and in various embodiments a computer system that operates as a mobile client computer in one environment may operate as a server computer in another environment, and vice versa. The mechanisms and apparatus of embodiments of the present invention apply equally to any appropriate computing system, including a computer system that does not employ the mobile client-server model.

While this disclosure has described the details of various embodiments shown in the drawings, these details are not intended to limit the scope of the invention as claimed in the appended claims.

What is claimed is:

1. A method for identifying resources for a mobile client, comprising:
acquiring information about a request made by a mobile client for network resources for a session;
predicting a predicted itinerary for the mobile client for the session;
predicting a predicted connection speed for the mobile client using the predicted itinerary for the session; and
identifying an identified network resource for the session using the predicted connection speed of the mobile client.

2. The method of claim 1, further comprising predicting a predicted duration of time of the session, wherein the predicting of the predicted itinerary uses the predicted duration of time for the session.

3. The method of claim 2, wherein the predicting of the predicted duration of time for the session uses historical data.

4. The method of claim 1, further comprising predicting a predicted path of travel for the mobile client, wherein the predicting of the predicted itinerary uses the predicted path of travel for the mobile client.

5. The method of claim 4, wherein predicting of the predicted path of travel for the mobile client uses historical data.

6. The method of claim 1, wherein the predicting of the predicted itinerary of the mobile client uses a global positioning system of the client.

7. The method of claim 1, wherein the predicting the predicted itinerary of the mobile client uses historical data.

8. The method of claim 1, further comprising: assigning the mobile client to the identified network resource.

9. The method of claim 1, wherein the identified network resource is a game server, further comprising assigning the mobile client to the game server.

10. A computer-readable storage medium having executable code stored thereon to cause a machine to identifying resources for a mobile client, comprising:
acquiring information about a request made by a mobile client for network resources for a session;
predicting a predicted itinerary for the mobile client for the session;
predicting a predicted connection speed for the mobile client using the predicted itinerary for the session; and
identifying an identified network resource for the session using the predicted connection speed of the mobile client.

11. The computer-readable storage medium of claim 10, further comprising predicting a predicted duration of time of the session, wherein the predicting of the predicted itinerary uses the predicted duration of time for the session.

12. The computer-readable storage medium of claim 11, wherein the predicting of the predicted duration of time for the session uses historical data.

13. The computer-readable storage medium of claim 10, further comprising predicting a predicted path of travel for the mobile client, wherein the predicting of the predicted itinerary uses the predicted path of travel for the mobile client.

14. The computer-readable storage medium of claim 13, wherein predicting the predicted path of travel for the mobile client uses historical data.

15. The computer-readable storage medium of claim 10, wherein the predicting the predicted itinerary of the mobile client uses a global positioning system of the client.

16. The computer-readable storage medium of claim 10, wherein the predicting the predicted itinerary of the mobile client uses historical data.

17. The computer-readable storage medium of claim 10, further comprising:
assigning the mobile client to the identified network resource.

18. The computer-readable storage medium of claim 10, wherein the identified network resource is a game server, further comprising assigning the mobile client to the game server.

19. A system for identifying resources for a mobile client, comprising a computer system, wherein the computer system is operable:
to receive a request for network resources from the mobile client;
to predict an itinerary for the mobile client for a session;
to predict a connection speed for the mobile client using the predicted itinerary for the session; and
to identify a network resource identified for the mobile client using the predicted connection speed of the mobile client.

20. The system of claim 19, further comprising the server being operable to predict a duration of time for the session.

21. The system of claim 19, further comprising a global positioning system in the mobile client to be used by the server to predict the itinerary for the mobile client for a session.

22. The system of claim 19, further comprising assigning the mobile client to the identified network resource.

23. The system of claim 19, wherein the network resource is a game server, further comprising assigning the mobile client to the game server.
